(19) United States
(12) Patent Application Publication
(10) Pub. No.: US 2023/0291169 A1
(43) Pub. Date: Sep. 14, 2023

(54) FREQUENCY STABLIZING SYSTEM AND METHOD FOR SINGLE-CAVITY MULTI-FREQUENCY COMB

(71) Applicants: Chongqing Institute of East China Normal University, Chongqing (CN); ROI Optoelectronics Technology CO, LTD., Shanghai (CN); Yunnan Huapu quantum Material Co., Ltd, Kunming (CN); GuangDong ROI Optoelectronics Technology Co., Ltd., Dongguan (CN); East China Normal University, Shanghai (CN); Chongqing Huapu Intelligent Equipment Co., Ltd., Chongqing (CN); Chongqing Huapu Quantum Technology Co., Ltd., Chongqing (CN)

(72) Inventors: Heping ZENG, Chongqing (CN); Zhengru GUO, Chongqing (CN); Tingting LIU, Chongqing (CN)

(21) Appl. No.: 18/181,683

(22) Filed: Mar. 10, 2023

(30) Foreign Application Priority Data
Mar. 11, 2022 (CN) 202210239209.8

(51) Int. Cl. H01S 3/13; H01S 3/1112; H01S 3/00; H01S 3/137; H01S 3/16

(52) U.S. Cl. CPC H01S 3/1305; H01S 3/0078; H01S 3/1112; H01S 3/137; H01S 3/1643

(57) ABSTRACT

A frequency stabilizing system for high precision single-cavity multi-frequency comb includes a single-cavity multi-comb pulse oscillator, a frequency detection system, and a frequency feedback control system. The single-cavity multi-comb pulse oscillator is configured to output mode-locked pulse trains with a certain repetition rate difference at two or more central wavelengths. The frequency detection system is configured to detect the frequency signal, and output the corresponding electrical signal. The frequency feedback control system is configured to process the electrical signal from the frequency detection system, and transmit it to the frequency response component in the single-cavity multi-comb pulse oscillator to control a strain of the frequency response component, so as to realize feedback control on the frequency (repetition rate, repetition rate difference, and carrier envelope offset frequency) of the mode-locked pulse trains.

### CROSS-REFERENCE TO RELATED APPLICATION

This application claims priority to Chinese Patent Application No. 202210239209.8, filed Mar. 11, 2022, the entire disclosure of which is incorporated herein by reference.

### FIELD

The present disclosure relates to the fields of laser technology and photoelectric control technology, in particular, to a frequency stabilizing system for high precision single-cavity multi-frequency comb and a frequency stabilizing method for high precision single-cavity multi-frequency comb.

### BACKGROUND

The emergence of optical frequency comb technology provides a new solution for precise optical measurement, which is an important achievement of the 2005 Nobel Prize winner in physics. Optical frequency combs are usually implemented based on mode-locked pulsed lasers, which appear as a series of frequency components at equal frequency intervals (laser repetition rate) in the frequency domain and as a train of equally spaced pulses in the time domain. Optical frequency comb technology has been widely used in spectroscopy technology. Coherent spectroscopy technology based on a multi-optical comb has the advantages of fast acquisition time, high sensitivity, and high resolution accuracy, and has shown great potential for application.

For multi-comb spectroscopy technology, the traditional method is to rely on multiple independent mode-locked pulse lasers with a certain repetition rate difference, and control their frequency information through complex and professional photoelectric conversion and detection technology, so as to realize multi-comb light source. The whole system is huge and complex, professional and fragile, which is not conducive to the development and promotion of multi-comb spectroscopy technology.

In recent years, researchers have developed a multi-wavelength laser that greatly simplifies the implementation of multi-comb light source. For example dual-wavelength mode-locked pulse laser can simultaneously output two mode-locked pulse trains at different wavebands (λ1 and λ2), corresponding to different repetition rates (f1 and f2, f1≠f2, f1-f2=Δf). Generally, dual-wavelength lasers are usually implemented based on a common resonator. The common-mode noise is effectively suppressed, and the coherence between the two wavelength pulses is greatly improved. The fluctuation pace of f1 and f2 are consistent, and Δf (the repetition rate difference) is jittered in a small range (on the order of Hz). The variation of the corresponding carrier envelope offset frequency (fceo) fceo1 and fceo2 also fluctuated in same pace, and a difference of Δfceo is relatively stable in a small range. Therefore, for this kind of multi-optical comb laser, to precisely control and stabilize all the frequencies information is crucial for realizing a high-precision multi-optical comb light source.

### SUMMARY

According to a first aspect of embodiments of the present disclosure, there is provided a frequency stablizing system for high precision single-cavity multi-frequency comb. The system includes a single-cavity multi-comb pulse oscillator configured to output mode-locked pulse trains with a certain repetition rate difference at two or more central wavelengths, in which the single-cavity multi-comb pulse oscillator includes an output port configured to split the mode-locked pulse trains according to the laser wavelength, and a frequency response component, a frequency detection system configured to receive split mode-locked pulse trains from the output port, detect the frequency signal, and output the corresponding electrical signal, and a frequency feedback control system configured to process the electrical signal from the frequency detection system, and transmit it to the frequency response component in the single-cavity multi-comb pulse oscillator, so as to realize feedback control on the frequency of the mode-locked pulse trains. The frequency response component is configured to respond to the electrical signal processed by the frequency feedback control system to perform separate locking of each frequency signal.

In some embodiments, the single-cavity multi-comb pulse oscillator is a dual-wavelength pulse oscillator, and the frequency response components include a repetition rate response component, a repetition rate difference response component, and a carrier envelope offset frequency difference response component, and the frequency response components do not interfere with each other during the frequency measurement and controlling.

In some embodiments, response parameters of the frequency response component are one or more of a laser cavity length, a medium refractive index, an intracavity dispersion coefficient, a central wavelength spacing of dual-wavelength pulses, pump power, and an intracavity nonlinear coefficient.

In some embodiments, a gain medium of the dual-wavelength pulse oscillator is a gain fiber or a gain crystal, in which the gain fiber includes one or more of erbium, ytterbium and thulium, and the gain crystal is one or more of Yb: YAG, Yb: CaF2 and Yb: KYW.

In some embodiments, the dual-wavelength pulse oscillator is a dual-wavelength optical fiber pulse oscillator, the repetition rate response component is configured to respond to the electrical signal according to a fiber refractive index to control the repetition rate, and the fiber refractive index is controlled by an all-optical method, the repetition rate difference response component is configured to respond to the electrical signal according to an intracavity dispersion coefficient to control a repetition rate difference, and the intracavity dispersion coefficient is controlled by stretching an intracavity chirped fiber grating with a motor, and the carrier envelope offset frequency difference response component is configured to respond to the electrical signal according to pump power to control a carrier envelope offset frequency difference.

In some embodiments, the dual-wavelength pulse oscillator is a dual-wavelength solid pulse oscillator, the repetition rate response component is configured to respond to the electrical signal according to the laser cavity length to control the repetition rate, and the laser cavity length is adjusted by piezoelectric actuators, the repetition rate difference response component is configured to respond to the electrical signal according to an intracavity dispersion coefficient to control a repetition rate difference, in which the intracavity dispersion coefficient is controlled by shifting and stretching the distance of intracavity grating pairs with a piezoelectric actuator, and the carrier envelope offset frequency difference response component is configured to respond to the electrical signal according to pump power to control a carrier envelope offset frequency difference.

In some embodiments, the dual-wavelength pulse oscillator is a dual-wavelength optical fiber pulse oscillator, the repetition rate response component is configured to respond to the electrical signal according to a fiber refractive index to control the repetition rate, and the fiber refractive index is controlled by an all-optical method, the repetition rate difference response component is configured to respond to the electrical signal according to an intracavity dispersion coefficient to control a repetition rate difference, and the intracavity dispersion coefficient is controlled by adjusting the temperature of a chirped fiber grating, and the carrier envelope offset frequency difference response component is configured to respond to the electrical signal according to pump power to control a carrier envelope offset frequency difference.

In some embodiments, the frequency detection system includes two independent repetition rate detection sub-systems and two independent carrier envelope offset frequency detection sub-systems, in which each repetition rate detection sub-system includes a beam splitter configured to split the optical signal output of the single-cavity multi-comb pulse oscillator according to the laser wavelength, a first photodetector configured to convert the optical signal into an electrical signal to realize photoelectric conversion, a first band-pass filter configured to select a fundamental repetition rate signal or a harmonic repetition rate signal from the electrical signal, a first radio frequency amplifier configured to perform power amplification on the filtered electrical signal, a frequency divider configured to divide the electrical signal into a detection monitoring signal and a feedback control signal, and a counter configured to observe and acquire frequency information of the electrical signal, in which each carrier envelope offset frequency detection sub-system includes an f-2f detector configured to detect the carrier envelope offset signal of the single-cavity multi-comb pulse oscillator, a second photodetector configured to convert the optical signal from the f-2f detector into an electrical signal to realize photoelectric conversion, a second band-pass filter configured to select a fundamental repetition rate signal or a harmonic repetition rate signal from the electrical signal from the second photodetector, and a second radio frequency amplifier configured to perform power amplification on the filtered electrical signal from second band-pass filter.

In some embodiments, the frequency feedback control system includes a repetition rate control component including a first signal generator, a first mixer, a first low-pass filter, and a third radio frequency amplifier, a repetition rate difference feedback control component including a first carrier modulator, a second signal generator, a second mixer, a second low-pass filter, and a fourth radio frequency amplifier, and a carrier envelope offset frequency difference feedback control component including a second carrier modulator, a third signal generator, a third mixer, a third low-pass filter, and a fifth radio frequency amplifier, in which each of the first carrier modulator and the second carrier modulator is configured to perform carrier modulation on a respective input signal, each of the first signal generator, the second signal generator and the third signal generator is configured to output a respective standard frequency signal, each of the first mixer, the second mixer and the third mixer is configured to mix the modulated signal with the standard frequency signal to obtain a respective error signal, each of the first low-pass filter, the second low-pass filter and the third low-pass filter is configured to filter the error signal, and each of the third radio frequency amplifier, the fourth radio frequency amplifier and the fifth radio frequency amplifier is configured to amplify the filtered error signal to realize feedback control.

According to a second aspect of embodiments of the present disclosure, there is provided a frequency stabilizing method for high precision single-cavity multi-frequency comb. By using a single-cavity multi-comb pulse oscillator, mode-locked pulse trains with a certain repetition rate difference at two or more central wavelengths are outputted. Then, by using a beam splitter, the optical signal is split into two or more beams according to the operating wavelength. Then the split optical signal is captured by a photoelectric detector to convert it into an electrical signal. The electrical signal is filtered, and the filtered electrical signal is amplified. By using a frequency divider, the amplified electrical signal is divided into several paths, and mixing, filtering, and amplifying is performed on each electrical signal. The amplified electrical signal is used as a feedback signal to drive a frequency response component of the single-cavity multi-comb pulse oscillator to realize feedback control of the frequency of the mode-locked pulse trains.

### BRIEF DESCRIPTION OF THE DRAWINGS

FIG. 1 is a schematic diagram showing a frequency stabilizing system for high precision single-cavity multi-frequency comb according to the present disclosure.

FIG. 2 is a schematic diagram showing a dual-wavelength pulse oscillator of a frequency stabilizing system for high precision single-cavity multi-frequency comb according to the present disclosure.

### DETAILED DESCRIPTION

The present disclosure aims to provide a frequency stabilizing system for high precision single-cavity multi-frequency comb and a frequency stabilizing method for high precision single-cavity multi-frequency comb, which may solve the problem of frequency drift of a multi-optical comb laser and realize precise control and stability of various frequencies.

The technical solution provided by the present disclosure is a frequency stabilizing system for high precision single-cavity multi-frequency comb including a single-cavity multi-comb pulse oscillator configured to output mode-locked pulse trains with a certain repetition rate difference at two or more central wavelengths, in which the single-cavity multi-comb pulse oscillator includes an output port configured to split the mode-locked pulse trains according to the laser wavelength, and a frequency response component, a frequency detection system configured to receive split mode-locked pulse trains from the output port, detect the frequency signal, and output the corresponding electrical signal, and a frequency feedback control system configured to process the electrical signal from the frequency detection system, and transmit it to the frequency response component in the single-cavity multi-comb pulse oscillator, so as to realize feedback control on the frequency of the mode-locked pulse trains, in which the frequency response component is configured to respond to the electrical signal processed by the frequency feedback control system to perform separate locking of each frequency signal.

The working principle and advantages of the present disclosure are as follows. For the mode-locked pulse trains with several repetition rates and a certain difference (different wavelengths corresponding to different repetition rates and carrier envelope offset frequencies) output by the single-cavity multi-comb pulse oscillator, the frequency detection system is configured to realize simultaneously detection of each mode-locked pulse train, and output the electrical signal. The frequency response component set in the pulse oscillator is fed back and controlled by the frequency feedback control system, so as to realize the stable controlling of each frequency signal of the dual-wavelength pulse train output from the output port, solve the problem of frequency drift of multi-comb laser, and realize the precise control and long-term stable laser frequencies. The frequency-stabllized single-cavity multi-comb light source can be used as an ultrafast optical comb light source with high stability, high mutual coherence and outdoor use, for high-precision distance detection, high-precision spectral measurement, high-speed optical fiber communication, high-precision frequency metrology, and other field of applications.

Further, the single-cavity multi-comb pulse oscillator is a dual-wavelength pulse oscillator, and the frequency response components include a repetition rate response component, a repetition rate difference response component, and a carrier envelope offset frequency difference response component, and the frequency response components should not interfere with each other.

For any mode-locked pulsed laser, the repetition rate can be represented by:

$$f = \frac{c}{n L}$$

where c is the speed of light, n is the medium refractive index, and L is the cavity length. Therefore, the overall cavity length and the refractive index are two main factors that affect the repetition rate.

Due to the difference between phase velocity and group velocity in dispersive medium inside a laser cavity, the pulse envelope drifts between pulses relative to the carrier phase, resulting in an overall offset of a frequency comb, referred to as the carrier envelope offset frequency (fceo). Correspondingly, the frequency of the optical mode is:

$${f}_{n} = {f}_{c e o} + N ∗ f$$

where n is the conversion factor between optical frequency and radio frequency. It can be seen that a high-precision optical frequency comb can be directly realized by realizing the precise control and locking of ƒ and ƒceo.

For a dual-wavelength laser, because there are two pulse trains at two wavelengths oscillated in the cavity, the repetition rate f1 is not equal to f2, there is a repetition rate difference:

$$Δ f = \frac{D L Δ λ}{{\overline{T}}^{2}}$$

where D is intracavity average dispersion, Δλ is wavelength separation, L is cavity length, and T̅ is average repetition period of two optical combs. D, L and Δλ are three key factors that affect the repetition rate difference Δf. In addition, L is also a key factor that affect the laser repetition rate (f1 or f2). Therefore, if the laser cavity length L is simply controlled, only one pulse repetition rate can be accurately controlled, and it is difficult to lock all repetition rate information of the dual-wavelength laser simultaneously. In addition, if feedback control is performed on L for both controlling of repetition rate and repetition rate difference, crosstalk will undoubtedly occur between two signals, resulting in that neither of them can be stabilized. Therefore, if the method of controlling L is used to control one of the repetition rate of the dual-wavelength laser, controlling of the repetition rate difference can only be performed by feedback control of D or Δλ. In this way, a dual-wavelength optical comb source with all stable repetition rate signal information can be realized.

In addition, due to a slight repetition rate difference between the two-path pulses, paths of the two-path pulses pass through the cavity are not exactly the same, so the carrier envelope offset frequency also has a certain jitter. Carrier envelope offset frequencies of the pulse trains with two wavelengths are denoted as fceo1 and fceo2, respectively, and their difference is denoted as Δfceo. Controlling fceo1 and fceo2 separately will induce mutual crosstalk, thus affecting the overall stability. Therefore, the carrier envelope offset frequency difference Δfceo is controlled in the present disclosure to avoid crosstalk between the frequency response components. Combined with the above control of all repetition rate information, all frequency information of the dual-wavelength optical comb source can be precicely controlled.

Further, response parameters of the frequency response component are one or more of a laser cavity length, a medium refractive index, an intracavity dispersion coefficient, a central wavelength spacing of dual-wavelength pulses, pump power, and an intracavity nonlinear coefficient.

According to the above formula, the repetition rate, the repetition rate difference, and the carrier envelope offset frequency difference can be accurately controlled by adjusting the response parameters of the frequency response component such as the cavity length, the medium refractive index, the intracavity dispersion coefficient, the central wavelength spacing of dual-wavelength pulses, the pump power, and the intracavity nonlinear coefficient of laser internal resonant cavity.

Further, a gain medium of the dual-wavelength pulse oscillator is a gain fiber or a gain crystal, in which the gain fiber includes one or more of erbium, ytterbium and thulium, and the gain crystal is one or more of Yb: YAG, Yb: CaF2 and Yb: KYW.

Further, the dual-wavelength pulse oscillator is a dual-wavelength optical fiber pulse oscillator, the repetition rate response component is configured to respond according to a fiber refractive index to control the repetition rate, and the fiber refractive index is controlled by an all-optical method, the repetition rate difference response component is configured to respond according to an intracavity dispersion coefficient to control a repetition rate difference, and the intracavity dispersion coefficient is controlled by stretching an intracavity chirped fiber grating with a motor, and the carrier envelope offset frequency difference response component is configured to respond according to pump power to control a carrier envelope offset frequency difference.

For the control method of each response component, the repetition rate is controlled by the all-optical method, the repetition rate difference is realized by stretching a length of the intracavity chirped fiber grating with the motor, and the carrier envelope offset frequency difference is realized by controlling a output power of pump source by a power feedback control component.

Further, the dual-wavelength pulse oscillator is a dual-wavelength solid pulse oscillator, the repetition rate response component is configured to respond according to the laser cavity length to control the repetition rate, and the laser cavity length is adjusted by piezoelectric actuators, the repetition rate difference response component is configured to respond according to an intracavity dispersion coefficient to control a repetition rate difference, in which the intracavity dispersion coefficient is controlled by shifting and stretching the distance of intracavity grating pairs with a piezoelectric actuator, and the carrier envelope offset frequency difference response component is configured to respond according to pump power to control a carrier envelope offset frequency difference.

For the other solution of the control method of each response component, the repetition rate is controlled by the piezoelectric actuator, the repetition rate difference is controlled by shifting the distance between intracavity grating pairs with piezoelectric actuator, and the carrier envelope offset frequency difference is controlled by controlling output power of pump source by a power feedback control component.

Further, the dual-wavelength pulse oscillator is a dual-wavelength optical fiber pulse oscillator, the repetition rate response component is configured to respond according to a fiber refractive index to control the repetition rate, and the fiber refractive index is controlled by an all-optical method, the repetition rate difference response component is configured to respond according to an intracavity dispersion coefficient to control a repetition rate difference, and the intracavity dispersion coefficient is controlled by adjusting the temperature of a chirped fiber grating, and the carrier envelope offset frequency difference response component is configured to respond according to pump power to control a carrier envelope offset frequency difference.

In addition to stretching the length of the chirped fiber grating to control the intracavity dispersion coefficient, the chirped fiber grating may also be placed on a semiconductor cooling chip or a temperature controller to adjust the temperature of the chirped fiber grating to realize the effect of controlling the intracavity dispersion coefficient, thus controlling the repetition rate difference.

Further, the frequency detection system includes two independent repetition rate detection sub-systems and two independent carrier envelope offset frequency detection sub-systems, in which each repetition rate detection sub-system includes a beam splitter configured to split the optical signal output of the single-cavity multi-comb pulse oscillator according to the laser wavelength, a first photodetector configured to convert the optical signal into an electrical signal to realize photoelectric conversion, a first band-pass filter configured to select a fundamental repetition rate signal or a harmonic repetition rate signal from the electrical signal, and filter out clutter, a first radio frequency amplifier configured to perform power amplification on the filtered electrical signal, a frequency divider configured to divide the electrical signal into a detection monitoring signal and a feedback control signal, and a counter configured to observe and acquire frequency information of the electrical signal, in which each carrier envelope offset frequency detection sub-system includes an f-2f detector configured to detect the carrier envelope offset signal of the the single-cavity multi-comb pulse oscillator, a second photodetector configured to convert the optical signal from the f-2f detector into an electrical signal to realize photoelectric conversion, a second band-pass filter configured to select a fundamental repetition rate signal or a harmonic repetition rate signal from the electrical signal from the second photodetector, and filter out clutter, and a second radio frequency amplifier configured to perform power amplification on the filtered electrical signal from second band-pass filter.

The frequency detection system includes two independent repetition rate detection sub-systems and two independent carrier envelope offset frequency detection sub-systems, which detects the repetition rate and the carrier envelope offset frequency respectively, thus improving the detection accuracy. At present, the prevailing method for fceo detection is f-2f method. The photoelectric conversion, filtering, amplification, frequency division, and counting are implemented step by step.

Further, the frequency feedback control system includes a repetition rate control component including a first signal generator, a first mixer, a first low-pass filter, and a third radio frequency amplifier, a repetition rate difference feedback control component including a first carrier modulator, a second signal generator, a second mixer, a second low-pass filter, and a fourth radio frequency amplifier, and a carrier envelope offset frequency difference feedback control component including a second carrier modulator, a third signal generator, a third mixer, a third low-pass filter, and a fifth radio frequency amplifier, in which each of the first carrier modulator and the second carrier modulator is configured to perform carrier modulation on a respective input signal, each of the first signal generator, the second signal generator and the third signal generator is configured to output a respective standard frequency signal, each of the first mixer, the second mixer and the third mixer is configured to mix the modulated signal with the standard frequency signal to obtain a respective error signal, each of the first low-pass filter, the second low-pass filter and the third low-pass filter is configured to filter the error signal, and each of the third radio frequency amplifier, the fourth radio frequency amplifier and the fifth radio frequency amplifier is configured to amplify the filtered error signal to realize feedback control.

The repetition rate feedback control component, the repetition rate difference feedback control component, and the carrier envelope offset frequency difference feedback control component perform feedback control on the repetition rate, the repetition rate difference, and the carrier envelope offset frequency difference, respectively. The carrier modulator is configured to perform carrier modulation on the input signal to make it fall within a working range of the relevant radio frequency components, and then performs mixing, filtering and amplifying to realize feedback control.

The present disclosure also provides a frequency stabilizing method for high precision single-cavity multi-frequency comb. The method uses the above system and includes by using a single-cavity multi-comb pulse oscillator, mode-locked pulse trains with a certain repetition rate difference at two or more central wavelengths are outputted. Then, by using a beam splitter, the optical signal is split into two or more beams according to the operating wavelength. Then the optical signal is captured by a photoelectric detector to convert it into an electrical signal. The electrical signal is filtered, and the filtered electrical signal is amplified. By using a frequency divider, the amplified electrical signal is divided into several paths, and mixing, filtering, and amplifying is performed on each electrical signal. The amplified electrical signal is used as a feedback signal to drive a frequency response component of the single-cavity multi-comb pulse oscillator to realize feedback control of the frequency of the mode-locked pulse trains.

The following is a further detailed description through specific embodiments.

The numerals in the accompanying drawings include: dual-wavelength pulse oscillator 100, laser 101, repetition rate response component 102, temperature control component 103, repetition rate difference response component 104, optical splitter 105, carrier envelope offset frequency difference response component 106, frequency detection system 200, repetition rate feedback control component 310, repetition rate difference feedback control component 320, carrier envelope offset frequency difference feedback control component 330.

Beam splitters 201, 211; photodetectors 202, 212, 232, 242; band-pass filters 203, 213, 233, 243; radio frequency amplifiers 204, 214, 234, 244, 314, 325, 336; frequency dividers 205, 206, 215; counters 207, 216, 222, 252; f-2f detectors 231, 241; mixers 311, 321, 323, 331, 334; signal generators 312, 326, 337; low-pass filters 313, 324, 335; carrier modulators 322, 323.

Semiconductor laser diode 109, plano-concave mirror 110, gain crystal 111, semiconductor saturable absorption mirror 112, grating pair 1024, motor controllers 1025, 1047, a piezoelectric actuator 1046.

(For the convenience of distinction, in this embodiment, the beam splitter, photodetector, band-pass filter, radio frequency amplifier, frequency divider, counter, f-2f detector, mixer, signal generator, low-pass filter, carrier modulator, and motor controller use different reference numerals, and all components are of the same model)

### Embodiment 1

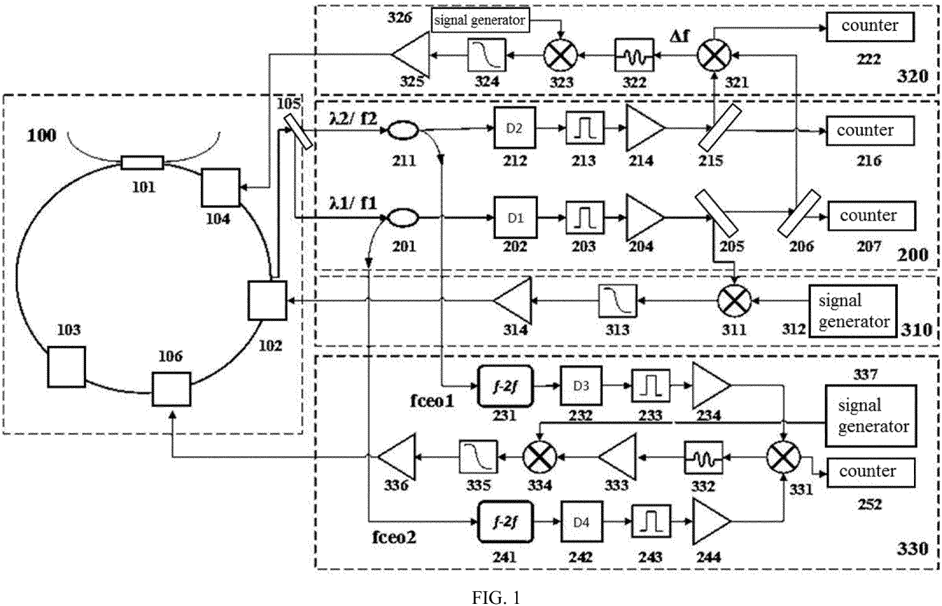

As shown in FIG. 1, a frequency stabilizing system for high precision single-cavity multi-frequency comb includes a single-cavity multi-comb pulse oscillator, a frequency detection system 200, and a frequency feedback control system. The frequency feedback control system includes a repetition rate feedback control component 310, a repetition rate difference feedback control component 320, and a carrier envelope offset frequency difference feedback control component 330. The single-cavity multi-comb pulse oscillator is a dual-wavelength pulse oscillator 100 (the dual-wavelength pulse oscillator 100 in this embodiment may be any one of a fiber laser, a solid-state laser, a semiconductor laser, or a gas laser that may realize dual-wavelength dual-pulse mode locking), and specifically includes a laser 101, an output port, and a frequency response component. The output port is an optical splitter 105. The frequency response component includes a repetition rate response component 102, a repetition rate difference response component 104, and a carrier envelope offset frequency difference response component 106.

The dual-wavelength pulse oscillator 100 includes a laser 101, a repetition rate response component 102, a temperature control component 103, a repetition rate difference response component 104, an optical splitter 105, and a carrier envelope offset frequency difference response component 106. The laser 101 may generate two mode-locked pulse trains with different central wavelengths, namely, λ1=1530 nm, and λ2=1560 nm, respectively, and a central wavelength spacing Δλ=30 nm. Assuming that corresponding repetition rates are f1=25.001 MHz and f2=25 MHz, respectively, a repetition rate difference Δf=1 kHz. Carrier envelope offset frequencies are fceo1=10 MHz and fceo2=10.001 MHz, respectively, then a carrier envelope offset frequency difference is Δfceo=1 kHz. An output signal is split according to a wavelength through the optical splitter 105, and then the two pulses will pass through a beam splitter 201 and a beam splitter 211, respectively. One path of repetition rate signal: λ1 (1530 nm) is detected by a photodetector 202 and converted into an electrical signal. λ2 (1560 nm) is detected by a photodetector 212 and is also converted into an electrical signal. In addition, one path of the carrier envelope offset frequency: two pulses will enter a carrier envelope offset frequency difference detection component.

The dual-wavelength pulse oscillator 100 is stably controlled by the temperature control component 103 as a whole to stabilize an operating wavelength of the oscillator. The repetition rate response component 102, the repetition rate difference response component 104, and the carrier envelope offset frequency difference response component 106 are configured to stabilize the repetition rate, the repetition rate difference, and the carrier envelope offset frequency difference, respectively. The optical splitter 105 is configured to separate dual-wavelength mode-locked pulse train signals according to a wavelength for independent measurement.

The frequency detection system 200 includes two independent repetition rate detection sub-systems and two independent carrier envelope offset frequency detection sub-systems. Next, for one path of the repetition rate signal, the dual-wavelength mode-locked pulse train enters the frequency detection system 200, respectively. The frequency detection system 200 includes beam splitters 201 and 211, photodetectors 202 and 212, band-pass filters 203 and 213, radio frequency amplifiers 204 and 214, frequency dividers 205, 206 and 215, and counters 207, 216 and 222. The 1530 nm signal light pulse sequentially passes through the beam splitter 201, the photodetector 202, the band-pass filter 203, the radio frequency amplifier 204, and the frequency dividers 205 and 206. One path of the output signals of the frequency divider 206 is connected to the counter 207 to realize the detection of the pulse repetition rate signal. The 1560 nm signal light pulse sequentially passes through the beam splitter 211, the photodetector 212, the band-pass filter 213, the radio frequency amplifier 214, and the frequency divider 215. One path of the output signals of frequency divider 215 is connected to the counter 216 to realize the detection of the pulse repetition rate signal.

The beam splitters 201 and 211 are configured to split the beams of 1530 nm and 1560 nm according to the intensity, and a splitting ratio is 5:5. The photodetectors 202 and 212 are configured to convert the optical signal into an electrical signal to realize the detection of the pulse signal. The photodetectors 202 and 212 may be various types of photodetectors such as PIN or APD. Both the band-pass filters 203 and 213 are band-pass filters with a central frequency of 25 MHz. A magnification of the radio frequency amplifier 204 is 23 dB, which is configured to amplify the 1530 nm signal. A magnification of the radio frequency amplifier 214 is 20 dB, which is configured to amplify the 1560 nm signal. The frequency divider 205 divides the 1530 nm signal amplified by the radio frequency amplifier 204 into two paths, one path is connected to the repetition rate feedback control component 310, and the other path is connected to the frequency divider 206. The frequency divider 206 continues to divide the 1530 nm signal into two paths, one path is connected to the counter 207 for repetition rate detection, and the other path is connected to the mixer 321 for mixing, and enters the subsequent repetition rate difference feedback control component 320. The frequency divider 215 divides the 1560 nm signal amplified by the radio frequency amplifier 214 into two paths, one path is connected to the counter 216 for repetition rate detection, and the other path is connected to the mixer 321 for mixing with the 1530 nm signal to obtain the repetition rate difference signal Δf =1 kHz, one path is connected to the counter 222 for repetition rate difference detection, and the other path is connected to the repetition rate difference feedback control component 320.

However, for one path of the carrier envelope offset frequency, split dual-wavelength pulses enter the f-2f carrier envelope offset detection components 231 and 241, photodetectors 232 and 242, band-pass filters 233 and 243, and radio frequency amplifiers 234 and 244, respectively. The f-2f carrier envelope offset detection components 231 and 241 are configured to detect the carrier envelope offset frequencies of the 1530 nm and 1560 nm signals, respectively. The photodetector converts an optical signal in the f-2f carrier envelope offset detection component into an electrical signal for subsequent detection. The photodetector is an APD type photodetector here.

The band-pass filters 233 and 243 are band-pass filters with a central frequency of 10 MHz and a bandwidth of 2 MHz. Amplification factors of the radio frequency amplifiers 234 and 244 are both 20 dB, which are configured to amplify fceo1 and fceo2 signals. Amplified two-path signals will be connected to a mixer 331 for mixing to obtain the carrier envelope offset frequency difference signal Δfceo=1 kHz, and then one path is connected to a counter 252 to detect the carrier envelope offset frequency difference, and the other path is connected to the carrier envelope offset frequency difference feedback control component 330.

The frequency feedback control system includes the repetition rate feedback control component 310, the repetition rate difference feedback control component 320, and the carrier envelope offset frequency difference feedback control component 330. The repetition rate feedback control component 310 includes a mixer 311, a signal generator 312, a low-pass filter 313, and a radio frequency amplifier 314. The repetition rate difference feedback control component 320 includes a mixer 321, a carrier modulator 322, a mixer 323, a signal generator 326, a low-pass filter 324, and a radio frequency amplifier 325. The carrier envelope offset frequency difference control component 330 includes a mixer 331, a carrier modulator 332, radio frequency amplifiers 333 and 336, a mixer 334, a low-pass filter 335, and a signal generator 337.

One path of 1530 nm pulse signal output by the frequency divider 205 enters the repetition rate feedback control component 310, and is sequentially processed by the mixer 311, the low-pass filter 313, and the radio frequency amplifier 314 to feedback control the repetition rate response component 102 in the dual-wavelength pulse oscillator 100, thus realizing the stable control of the repetition rate signal of the dual-wavelength laser of the present disclosure.

The repetition rate difference signal Δf output by the mixer 321 enters the repetition rate difference feedback control component 320, and is sequentially processed by the carrier modulator 322, the mixer 323, the low-pass filter 324, and the radio frequency amplifier 325 to feedback control the repetition rate difference response component 104 in the dual-wavelength pulse oscillator 100, thus realizing stable control of the repetition rate difference signal of the dual-wavelength laser of the present disclosure.

The carrier modulator 322 will generate a modulation frequency of 15 MHz for raising the frequency of the repetition rate difference signal to 15.001 MHz, so that it falls within the working range of the mixer 323. The radio frequency mixers 311 and 323 are configured to perform mixing operations on the repetition rate signal or the repetition rate difference signal respectively, and perform frequency difference with standard frequency signals output by the signal generators 312 and 326 respectively to obtain error signals as a feedback signals to drive the corresponding frequency response components. The signal generator 312 outputs a standard frequency signal of 25 MHz, and the waveform is a sine wave. The signal generator 326 outputs a standard frequency signal of 15 MHz, and the waveform is a sine wave.

The low-pass filter 313 and the radio frequency amplifier 314 are configured to extract and amplify the repetition rate error signal, so as to realize the feedback control of the repetition rate response component 102.

The low-pass filter 324 and the radio frequency amplifier 325 are configured to extract and amplify the repetition rate difference error signal, so as to realize the feedback control of the repetition rate difference response component 104.

For carrier envelope offset frequency detection locking, the carrier envelope offset frequency difference signal Δfceo after the detected two carrier envelope offset frequencies fceo1 and fceo2 pass through the mixer 331 enters the carrier envelope offset frequency difference feedback control component 330, and is sequentially processed by the carrier modulator 332, the radio frequency amplifier 333, the mixer 334, the low frequency filter 335, and the radio frequency amplifier 336 to feedback control the carrier envelope offset frequency difference response component 106 in the dual-wavelength pulse oscillator 100, thus realizing stable control of the carrier envelope offset frequency difference signal of the dual-wavelength laser of the present disclosure.

The carrier modulator 322 will generate a modulation frequency of 15 MHz for raising the carrier envelope offset frequency difference signal to 15.001 MHz, so that it falls within the working range of the radio frequency mixer 334, and then passes through the radio frequency amplifier 333 with a magnification of 20 dB. The mixer 334 is configured to mix the 15 MHz sinusoidal standard signal generated by the signal generator 337 with the modulated carrier envelope offset frequency difference signal to obtain an error signal. The low-pass filter 335 and the radio frequency amplifier 336 with a magnification of 20 dB are configured to extract and amplify the carrier envelope offset frequency difference error signal, so as to realize the feedback control of the frequency response component 106.

The dual-wavelength pulse oscillator 100 is a dual-wavelength optical fiber pulse oscillator. The laser 101 includes a semiconductor laser diode (LD) of 980 nm, and its output pump laser is pumped through a four-port wavelength division multiplexer to pump the gain fiber to obtain signal light at 1550 nm, and then the signal light passes through the mode-locked modulator to obtain a mode-locked pulse signal. In this embodiment, the optical fiber and optical fiber component used are both polarization maintaining elements (polarization maintaining optical fibers).

The repetition rate response component 102 adopts an all-optical method to control the repetition rate of the oscillator, including a circulator, a wavelength division multiplexer, a semiconductor laser diode, a gain fiber, and a chirped fiber grating. The circulator introduces intracavity signal into the grating and introduces signal light reflected by the grating back into the laser cavity. The central wavelength of the semiconductor laser diode should be 980 nm. The gain fiber 1044 is pumped through the 980/1550 three-port wavelength division multiplexer 1042 to produce the change of refractive index, so as to control the repetition rate in the oscillator cavity. The repetition rate feedback control component 310 controls the change of the refractive index of the gain fiber by changing the pumping power of the laser diode, which affects the optical path, thus controlling the repetition rate. The chirped fiber grating is to be high reflection at 1530 nm and 1560 nm, and high transmission at 980 nm.

The repetition rate difference frequency response component include a circulator, a chirped fiber grating, and a pressure controller. The circulator introduces intracavity signal into the grating and introduces signal light reflected by the grating back into the laser cavity. The feedback signal generated by the repetition rate difference feedback control component 320 controls a length of the CGBG by stretching with a motor, thus controlling the overall intracavity dispersion, and realizing the stable control of the repetition rate difference of the dual-wavelength laser. Parameters of the chirped fiber grating are as follows. The working wavelength is 1520 nm to 1560 nm, the bandwidth is 40 nm, the reflectivity is greater than 80%, and the fiber type is a polarization-maintaining optical fiber. Length stretching or temperature control may be made to provide a second-order dispersion parameter that is adjustable in the range of 0.01 to 0.2ps2.

The motor may also be replaced with a temperature controller or a semiconductor refrigeration chip, and the temperature of the chirped fiber grating may be adjusted to achieve the effect of controlling the intracavity dispersion coefficient, thus realizing the control of the repetition rate difference.

The carrier envelope offset frequency difference frequency response component adopts the control pump power to control the oscillator carrier envelope offset frequency difference. The carrier envelope offset frequency difference feedback control component 330 changes the intracavity nonlinear coefficient by changing the power of the semiconductor laser diode, thus finally realizing the control of the carrier envelope offset frequency difference.

In addition to the above-mentioned frequency response component combination, the repetition rate response component 102 may also adopt the combination of a chirped fiber grating plus an electrically controlled polarization controller, a grating pair plus an all-optical method to control the cavity length, a chirped fiber grating plus a piezoelectric actuator controller, and a grating pair plus an electrically controlled polarization controller, etc. The carrier envelope offset frequency difference response component 106 may also adopt a method of controlling an intracavity nonlinear device.

In this embodiment, the gain fiber includes one or more of erbium, ytterbium, and thulium.

### Embodiment 2

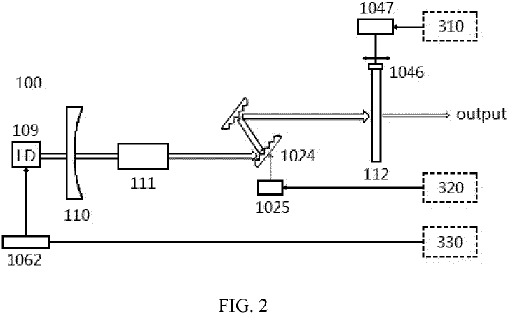

The difference between Embodiment 2 and Embodiment 1 is that the dual-wavelength pulse oscillator 100 is a dual-wavelength solid-state pulse oscillator, and the output port is a coupler. A structure of the pulse oscillator is shown in FIG. 2, including a laser 101, a coupler, a plano-concave mirror 110, a gain crystal 111, a grating pair 1024, a motor controller 1025, a motor controller 1047, and a piezoelectric actuator 1046. The laser 101 is a semiconductor laser diode 109, and the coupler is a semiconductor saturable absorption mirror 112.

The semiconductor laser diode 109 of 980 nm is antireflective through 980 nm, and the gain crystal 111 is pumped by a 1030 high-reflection plano-concave mirror 110 to generate 1030 nm band signal light, and then the signal light is output through a semi-transparent and semi-reflecting semiconductor saturable absorption mirror 112. The grating pair 1024 is configured to compensate an intracavity dispersion coefficient of the oscillator and as the repetition rate response component 102 for stabilizing the repetition rate difference. The semiconductor saturable absorption mirror 112 is not only used as an output coupling mirror, but also used as a saturable absorption material for generating dual-wavelength mode-locked pulse output, and as a repetition rate response component 102 to realize stable control of the laser repetition rate.

The repetition rate response component 102 includes the grating pair 1024 and the motor controller 1025. One of the gratings in the grating pair 1024 is adhered to the motor controller 1025, and a position and an angle may be changed following the grating. The feedback signal generated by the repetition rate difference feedback control component 320 controls an angle and distance of the grating pair 1024 through the motor controller 1025, thus changing the overall intracavity dispersion, and realizing the locking of the dual wavelength pulse repetition rate difference.

The repetition rate difference response component 104 includes the semiconductor saturable absorption mirror 112, the piezoelectric actuator 1046 and the motor controller 1047. The semiconductor saturable absorption mirror 112 is adhered to the piezoelectric actuator 1046. The repetition rate feedback control component 310 generates a feedback signal, and controls the piezoelectric actuator 1046 through the motor controller 1047, thus changing a position of the semiconductor saturable absorption mirror 112, changing an overall cavity length, and realizing the stable control of the repetition rate of the dual-wavelength pulse oscillator 100.

The carrier envelope offset frequency difference frequency response component 106 adopts the control pump power to control the oscillator carrier envelope offset frequency difference. The carrier envelope offset frequency difference feedback control component 330 changes the intracavity nonlinear coefficient by changing the power of the semiconductor laser diode 109, and finally realizes the control of the carrier envelope offset frequency difference.

The gain crystal is one or more of Yb: YAG, Yb: CaF2 and Yb: KYW.

### Embodiment 3

The difference between Embodiment 3 and Embodiment 2 is that the carrier envelope offset frequency difference frequency response component 106 has an output cavity mirror inserted between the gain crystal 111 and the grating pair 1024. In this embodiment, the output cavity mirror is a glass wedge. The intracavity nonlinear coefficient is changed by controlling and adjusting an angle of the glass wedge, thus realizing the control of the carrier envelope offset frequency difference.

The embodiment of the present disclosure also discloses a frequency stabilizing method for high precision single-cavity multi-frequency comb, which uses the above-mentioned system.

The above description is only an embodiment of the present disclosure. The common knowledge such as the well-known specific structures and characteristics in the solution is not described too much here. Those skilled in the art know all the common technical knowledge in the technical field to which the present disclosure belongs before the filing date or the priority date, may know all the existing technologies in the art, and have the ability to apply conventional experimental means before the date. Those skilled in the art may improve and implement the solution in combination with their own ability under the inspiration obtained in the present disclosure, and some typical well-known structures or well-known methods should not be an obstacle to those skilled in the art from practicing the present disclosure. It should be pointed out that for those skilled in the art, several modifications and improvements may be made without departing from the structure of the present disclosure, which should also be regarded as the protection scope of the present disclosure, and these will not affect the effectiveness of the present disclosure and the utility of the patent. The scope of protection claimed in the present disclosure should be determined by the contents of the claims, and the contents described in the description, such as specific implementation, may be used to interpret the contents of the claims.

What is claimed is:

1. A system for single-cavity multi-frequency comb, comprising:
a single-cavity multi-comb pulse oscillator configured to output mode-locked pulse trains with a certain repetition rate difference at two or more central wavelengths; wherein the single-cavity multi-comb pulse oscillator comprises:
an output port configured to split the mode-locked pulse trains according to the laser wavelength; and
a frequency response component;
a frequency detection system configured to receive split mode-locked pulse trains from the output port, detect the frequency signal, and output the corresponding electrical signal; and
a frequency feedback control system configured to process the electrical signal from the frequency detection system, and transmit it to the frequency response component in the single-cavity multi-comb pulse oscillator, so as to realize feedback control on the frequency of the mode-locked pulse trains,
wherein the frequency response component is configured to respond to the electrical signal processed by the frequency feedback control system to perform separate locking of each frequency signal.

2. The system for single-cavity multi-frequency comb of claim 1, wherein the single-cavity multi-comb pulse oscillator is a dual-wavelength pulse oscillator, and the frequency response component comprises a repetition rate response component, a repetition rate difference response component, and a carrier envelope offset frequency difference response component, and the frequency response components do not interfere with each other during the frequency measurement and controlling.

3. The system for single-cavity multi-frequency comb of claim 2, wherein response parameters of the frequency response component are one or more of a laser cavity length, a medium refractive index, an intracavity dispersion coefficient, a central wavelength spacing of dual-wavelength pulses, pump power, and an intracavity nonlinear coefficient.

4. The system for single-cavity multi-frequency comb of claim 2, wherein a gain medium of the dual-wavelength pulse oscillator is a gain fiber or a gain crystal, wherein the gain fiber comprises one or more of erbium, ytterbium and thulium, and the gain crystal is one or more of Yb: YAG, Yb: CaF₂ and Yb: KYW.

5. The system for single-cavity multi-frequency comb of claim 2, wherein:
the dual-wavelength pulse oscillator is a dual-wavelength optical fiber pulse oscillator, the repetition rate response component is configured to respond to the electrical signal according to a fiber refractive index to control the repetition rate, and the fiber refractive index is controlled by an all-optical method;
the repetition rate difference response component is configured to respond to the electrical signal according to an intracavity dispersion coefficient to control a repetition rate difference, and the intracavity dispersion coefficient is controlled by stretching an intracavity chirped fiber grating with a motor; and
the carrier envelope offset frequency difference response component is configured to respond to the electrical signal according to pump power to control a carrier envelope offset frequency difference.

6. The system for single-cavity multi-frequency comb of claim 5, wherein the frequency detection system comprises two independent repetition rate detection sub-systems and two independent carrier envelope offset frequency detection sub-systems;
wherein each repetition rate detection sub-system comprises:
a beam splitter configured to split the optical signal output of the single-cavity multi-comb pulse oscillator according to the laser wavelength;
a first photodetector configured to convert the optical signal into an electrical signal to realize photoelectric conversion;
a first band-pass filter configured to select a fundamental repetition rate signal or a harmonic repetition rate signal from the electrical signal;
a first radio frequency amplifier configured to perform power amplification on the filtered electrical signal;
a frequency divider configured to divide the electrical signal into a detection monitoring signal and a feedback control signal, and
a counter configured to observe and acquire frequency information of the electrical signal; wherein each carrier envelope offset frequency detection sub-system comprises:
an f-2f detector configured to detect the carrier envelope offset signal of the single-cavity multi-comb pulse oscillator;
a second photodetector configured to convert the optical signal from the f-2f detector into an electrical signal to realize photoelectric conversion;
a second band-pass filter configured to select a fundamental repetition rate signal or a harmonic repetition rate signal from the electrical signal from the second photodetector; and
a second radio frequency amplifier configured to perform power amplification on the filtered electrical signal from second band-pass filter.

7. The system for single-cavity multi-frequency comb of claim 5, wherein the frequency feedback control system comprises:
a repetition rate control component comprising a first signal generator, a first mixer, a first low-pass filter, and a third radio frequency amplifier;
a repetition rate difference feedback control component comprising a first carrier modulator, a second signal generator, a second mixer, a second low-pass filter, and a fourth radio frequency amplifier; and
a carrier envelope offset frequency difference feedback control component comprising a second carrier modulator, a third signal generator, a third mixer, a third low-pass filter, and a fifth radio frequency amplifier;
wherein each of the first carrier modulator and the second carrier modulator is configured to perform carrier modulation on a respective input signal, each of the first signal generator, the second signal generator and the third signal generator is configured to output a respective standard frequency signal, each of the first mixer, the second mixer and the third mixer is configured to mix the modulated signal with the standard frequency signal to obtain a respective error signal, each of the first low-pass filter, the second low-pass filter and the third low-pass filter is configured to filter the error signal, and each of the third radio frequency amplifier, the fourth radio frequency amplifier and the fifth radio frequency amplifier is configured to amplify the filtered error signal to realize feedback control.

8. The system for single-cavity multi-frequency comb of claim 2, wherein:
the dual-wavelength pulse oscillator is a dual-wavelength solid pulse oscillator, the repetition rate response component is configured to respond to the electrical signal according to the laser cavity length to control the repetition rate, and the laser cavity length is adjusted by piezoelectric actuators;
the repetition rate difference response component is configured to respond to the electrical signal according to an intracavity dispersion coefficient to control a repetition rate difference, wherein the intracavity dispersion coefficient is controlled by shifting and stretching the distance of intracavity grating pairs with a piezoelectric actuator; and
the carrier envelope offset frequency difference response component is configured to respond to the electrical signal according to pump power to control a carrier envelope offset frequency difference.

9. The system for single-cavity multi-frequency comb of claim 8, wherein the frequency detection system comprises two independent repetition rate detection sub-systems and two independent carrier envelope offset frequency detection sub-systems;
wherein each repetition rate detection sub-system comprises:
a beam splitter configured to split the optical signal output of the single-cavity multi-comb pulse oscillator according to the laser wavelength;
a first photodetector configured to convert the optical signal into an electrical signal to realize photoelectric conversion;
a first band-pass filter configured to select a fundamental repetition rate signal or a harmonic repetition rate signal from the electrical signal;
a first radio frequency amplifier configured to perform power amplification on the filtered electrical signal;
a frequency divider configured to divide the electrical signal into a detection monitoring signal and a feedback control signal, and
a counter configured to observe and acquire frequency information of the electrical signal; wherein each carrier envelope offset frequency detection sub-system comprises:
an f-2f detector configured to detect the carrier envelope offset signal of the single-cavity multi-comb pulse oscillator;
a second photodetector configured to convert the optical signal from the f-2f detector into an electrical signal to realize photoelectric conversion;
a second band-pass filter configured to select a fundamental repetition rate signal or a harmonic repetition rate signal from the electrical signal from the second photodetector; and
a second radio frequency amplifier configured to perform power amplification on the filtered electrical signal from second band-pass filter.

10. The system for single-cavity multi-frequency comb of claim 8, wherein the frequency feedback control system comprises:
a repetition rate control component comprising a first signal generator, a first mixer, a first low-pass filter, and a third radio frequency amplifier;
a repetition rate difference feedback control component comprising a first carrier modulator, a second signal generator, a second mixer, a second low-pass filter, and a fourth radio frequency amplifier; and
a carrier envelope offset frequency difference feedback control component comprising a second carrier modulator, a third signal generator, a third mixer, a third low-pass filter, and a fifth radio frequency amplifier;
wherein each of the first carrier modulator and the second carrier modulator is configured to perform carrier modulation on a respective input signal, each of the first signal generator, the second signal generator and the third signal generator is configured to output a respective standard frequency signal, each of the first mixer, the second mixer and the third mixer is configured to mix the modulated signal with the standard frequency signal to obtain a respective error signal, each of the first low-pass filter, the second low-pass filter and the third low-pass filter is configured to filter the error signal, and each of the third radio frequency amplifier, the fourth radio frequency amplifier and the fifth radio frequency amplifier is configured to amplify the filtered error signal to realize feedback control.

11. The system for single-cavity multi-frequency comb of claim 2, wherein:
the dual-wavelength pulse oscillator is a dual-wavelength optical fiber pulse oscillator, the repetition rate response component is configured to respond to the electrical signal according to a fiber refractive index to control the repetition rate, and the fiber refractive index is controlled by an all-optical method;
the repetition rate difference response component is configured to respond to the electrical signal according to an intracavity dispersion coefficient to control a repetition rate difference, and the intracavity dispersion coefficient is controlled by adjusting the temperature of a chirped fiber grating; and
the carrier envelope offset frequency difference response component is configured to respond to the electrical signal according to pump power to control a carrier envelope offset frequency difference.

12. The system for single-cavity multi-frequency comb of claim 11, wherein the frequency detection system comprises two independent repetition rate detection sub-systems and two independent carrier envelope offset frequency detection sub-systems;
wherein each repetition rate detection sub-system comprises:
a beam splitter configured to split the optical signal output of the single-cavity multi-comb pulse oscillator according to the laser wavelength;
a first photodetector configured to convert the optical signal into an electrical signal to realize photoelectric conversion;
a first band-pass filter configured to select a fundamental repetition rate signal or a harmonic repetition rate signal from the electrical signal;
a first radio frequency amplifier configured to perform power amplification on the filtered electrical signal;
a frequency divider configured to divide the electrical signal into a detection monitoring signal and a feedback control signal, and
a counter configured to observe and acquire frequency information of the electrical signal; wherein each carrier envelope offset frequency detection sub-system comprises:
an f-2f detector configured to detect the carrier envelope offset signal of the single-cavity multi-comb pulse oscillator;
a second photodetector configured to convert the optical signal from the f-2f detector into an electrical signal to realize photoelectric conversion;
a second band-pass filter configured to select a fundamental repetition rate signal or a harmonic repetition rate signal from the electrical signal from the second photodetector; and
a second radio frequency amplifier configured to perform power amplification on the filtered electrical signal from second band-pass filter.

13. The system for single-cavity multi-frequency comb of claim 11, wherein the frequency feedback control system comprises:
a repetition rate control component comprising a first signal generator, a first mixer, a first low-pass filter, and a third radio frequency amplifier;
a repetition rate difference feedback control component comprising a first carrier modulator, a second signal generator, a second mixer, a second low-pass filter, and a fourth radio frequency amplifier; and
a carrier envelope offset frequency difference feedback control component comprising a second carrier modulator, a third signal generator, a third mixer, a third low-pass filter, and a fifth radio frequency amplifier;
wherein each of the first carrier modulator and the second carrier modulator is configured to perform carrier modulation on a respective input signal, each of the first signal generator, the second signal generator and the third signal generator is configured to output a respective standard frequency signal, each of the first mixer, the second mixer and the third mixer is configured to mix the modulated signal with the standard frequency signal to obtain a respective error signal, each of the first low-pass filter, the second low-pass filter and the third low-pass filter is configured to filter the error signal, and each of the third radio frequency amplifier, the fourth radio frequency amplifier and the fifth radio frequency amplifier is configured to amplify the filtered error signal to realize feedback control.

14. A method for single-cavity multi-frequency comb, comprising:
outputting, by using a single-cavity multi-comb pulse oscillator, mode-locked pulse trains with a certain repetition rate difference at two or more central wavelengths;
splitting, by using a beam splitter, the optical signal into two or more beams according to the operating wavelength;
capturing, by a photoelectric detector, the split optical signal to convert it into an electrical signal;
filtering the electrical signal, and amplifying the filtered electrical signal;
dividing, by using a frequency divider, the amplified electrical signal into several paths, and performing mixing, filtering, and amplifying on each electrical signal;
using the amplified electrical signal as a feedback signal to drive a frequency response component of the single-cavity multi-comb pulse oscillator to realize feedback control of the frequency of the mode-locked pulse trains.
